(19) United States
(12) Patent Application Publication
(10) Pub. No.: US 2026/0300121 A1
(43) Pub. Date: Oct. 1, 2026

(54) LLM-BASED PROCESS FOR QUANTUM RESOURCE ESTIMATES

(71) Applicant: Dell Products L.P., Round Rock, TX (US)

(72) Inventors: Diego Vrague Noble, Pelotas (BR); Ítalo Gomes Santana, Rio de Janeiro (BR); Miguel Paredes Quiñones, Campinas (BR)

(21) Appl. No.: 19/093,159

(22) Filed: Mar. 27, 2025

(51) Int. Cl. G06F 11/34; G06N 10/60

(52) U.S. Cl. CPC G06F 11/3442; G06N 10/60

(57) ABSTRACT

One example method includes receiving, by an LLM (large language model), an input prompt that includes a description of a problem to be solved using quantum computing resources, by each QRE (quantum resource estimator) in an ensemble, determining, as an output of the QRE, a result that indicates the quantum computing resources needed to solve the problem, merging the QRE output results to generate a unified result, generating a list of available quantum computing resources that are able to meet requirements specified in the unified result, generating an output that is based on the list, and providing the output to the LLM, which uses the output to generate a human-readable output of the resources needed to solve the problem.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to resolution of problems using quantum hardware. More particularly, at least some embodiments relate to systems, hardware, software, computer-readable media, and methods, for LLM-based processes for generating quantum resource estimates.

### BACKGROUND

There is often a need to know, prior to solving a particular problem, which quantum hardware is equal to the task. However, updated official information about vendors of quantum hardware are dynamic and changes rapidly since there is a race on the development of quantum hardware development. Moreover, interpreting the outputs of a QRE (quantum resource estimator) is challenging as it may not indicate clearly to non-expert users which quantum computer is available in the market, or in a future release, which one could be used to solve the input problem. Further, QREs are highly sensitive tools and typically require a number of assumptions in their implementation. These assumptions are not always clear, and are sometimes not understandable to non-expert stakeholders.

In more detail, QREs are tools designed to predict the amount of resources that a given quantum circuit will require to be executed on fault-tolerant quantum computers (FTQCs) to solve a particular problem. Some of the expected outputs of a QRE may be, for example, the number of gates and physical/logical qubits, execution time, and details about logical qubits. The assumption that FTQCs will be employed demands that QREs must also regard quantum error correction (QEC) algorithms as an intermediate process to make QREs useful in current quantum computers, which are not fault-tolerant. Finally, a drawback present in conventional QREs regards the interpretation of their outputs, especially because these outputs are often quite technical in nature, such that they are not understandable by non-expert users, such as business executives for example, in taking informed decisions for their roadmaps in quantum. Such roadmaps might include, for example: one qubit gate error rate; two qubit gate error rate; readout error rate; one qubit gate execution time; two qubit gate execution time; readout time; and, number of qubits and cost models.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a schema, according to one embodiment.

FIG. 2 discloses aspects of an embodiment of a computing entity configured and operable to perform any of the disclosed methods, processes, and operations.

### DETAILED DESCRIPTION OF SOME EXAMPLE EMBODIMENTS

Embodiments disclosed herein generally relate to resolution of problems using quantum hardware. More particularly, at least some embodiments relate to systems, hardware, software, computer-readable media, and methods, for LLM-based processes for generating quantum resource estimates.

In general, example embodiments comprise methods, architectures, and schemas, for determining the quantum resources needed to solve a specified problem. In one or more embodiments, an LLM (Large Language Model) is used to render information about the quantum resources into a form readily understandable by a human user. To this end, the LLM may receive unstructured input, such as a prompt (text-instruction) containing a description of a problem to be solved, and return that unstructured input in a structured form.

A method according to one example embodiment may comprise various operations including, but not limited to: receiving, by an LLM, a prompt that comprises a description of a problem to be solved using quantum computing resources; converting, by the LLM, the prompt to a structured form; for each QRE in an ensemble, using the QRE to determine, as an output, the quantum computing resources needed to solve the problem; merging the QRE outputs to generate a unified result; generating a list of available quantum computing resources that are able to meet requirements specified in the unified result; providing the list as an input to the LLM; and transmitting, by the LLM, a human readable version of the list.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may decrease a cost incurred by non-experts in entering in the quantum domain by providing a more user friendly and intuitive interface that enables a non-expert or other lay person to understand the quantum resource requirements for one or more problems. An embodiment may improve interpretability of QRE results, which may lead to a more robust and informed decision-making process for supporting non-expert users. Various other advantages of one or more example embodiments will be apparent from this disclosure.

### A. Detailed Discussion of Aspects of one or More Embodiments

### A.1 Introduction

As a way of mitigating challenges such as those noted herein, an example embodiment may use a Large Language Model (LLM) to transform outputs generated by one or more QREs into a more user-friendly form. However, a simple well-trained LLM may not be enough to address this challenge, particularly if a non-expert is interested in an augmented answer from other external sources. For example, which quantum machines are likely to meet the requirements output by a QRE and how the problem would perform on a specific quantum machine. A method and LLM according to one or more embodiments may be effective in resolving these concerns.

### A.2 Overview of Aspects of one or More Embodiments

In an embodiment, D refers to a database containing technical information about a pool of quantum devices that may be considered for use in solving a problem. Each transaction of D comprises a set of features of a given quantum resource, such as a quantum hardware configuration, such as may be available to solve a specified problem. Some example features, or specifications, may include, among other things, the number of qubits, statistics about gate errors, coupling map, T1 and T2 times, hybridization with classical computing, technology—for example, spin, neutral atoms, and photonic—and release date.

For each feature, the information, or data representation, should be uniform, such as by having the same scale, measures, and format, for example, so as to enable comparisons among the quantum resources, or simply ‘devices.’ In an embodiment, the modelling of D may enable unstructured data to be inserted in each transaction as a feature so that the particularities of a device, that may not be directly comparable to other devices, can be included. Such unstructured information may comprise a summary of specific capabilities of the associated device, for example, a benchmark result for the quantum volume.

With regards to the currency of D, embodiments contemplate various ways of keeping D updated, manually and/or automatically. In one example of a manual approach for updating D, an administrator inputs new information with regards to quantum advantage whenever that information becomes available. This approach may be employed in Retrieval-Augmented Generation (RAG) systems. In one example of an automated approach for updating D, another system may operate to gather device information from common and trustable sources from time to time.

As well, and with continued reference to the database D, an embodiment of that database may include both the specifications of currently available devices, as well as information concerning hypothetical future devices, such as may be found, for example, in vendor roadmaps. In an embodiment, any missing features of a hypothetical future device may be imputed by subject matter experts (SME) and/or may be captured by web crawlers from trustworthy online sources. Additionally, new features may be added to D to indicate whether a device is a real one, or a hypothetical one. This information may be used to enhance the final answer for the LLM.

### A.3 Detailed Discussion

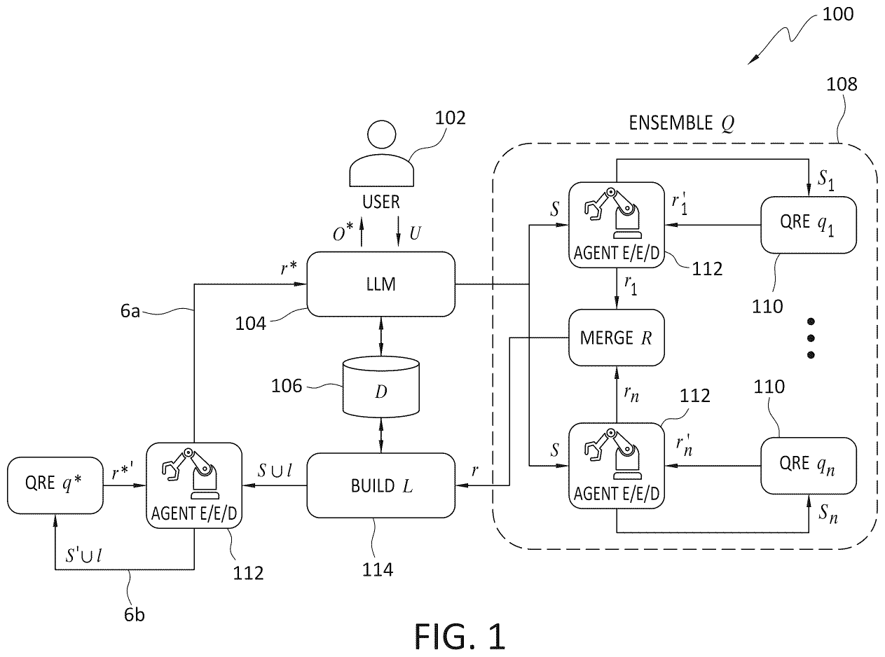

With reference now to FIG. 1, an example schema 100 according to one embodiment is disclosed. One example embodiment of a method performed according to the schema 100 may comprise various operations. These operations are addressed in detail below.

In particular, and with detailed reference now to the example of FIG. 1, a method according to one example embodiment may proceed as follows:
1. A user 102 provides to an LLM 104 a prompt U containing a detailed description of a problem that the user 102 would like to solve, including the size and target solution quality, that is, minimum acceptable accuracy, of the problem. The intention of the user 102 is to determine the hardware requirements for solving this input problem, and which quantum machines available in the database D 106 are likely to be able to solve it.
2. An objective of the LLM 104 is to receive an unstructured input U and return it in a structured form S. One embodiment considers that U is a text, and a S is a dictionary-like text—for example, a hashtable, or key-value pairs as represented in JSON (JavaScript Object Notation) files. In other words, an embodiment may assume that the LLM 104 is trained specifically to convert U into S.
3. Next, given an ensemble Q 108 of distinct QREs 110, where each q∈Q will receive the same S as input. As some QREs 110 may need a specific conversion on S to receive it as input, for example, input parameter names and values in specific scales, an embodiment may employ respective agents 112 to convert S for each q and obtain the resource requirements information from q. In an embodiment, and as shown in FIG. 1, one or more of the agents 112 may comprise a respective Agent E/E/D (encode, execute, and decode) one of which may be associated with the QRE 110 q₁. This agent 112 may encode S to q₁, resulting in S₁, which may be provided as input to the QRE 110. The QRE 110 may then execute the q₁ utilizing S₁ as input, and collects the results r₁, that is, the results by the QRE 110 identifying estimated quantum computing resources needed for solving the input problem. The QRE 110 may then decode the results r₁ as r′₁ which may be provided to the agent 112. The decoding process referred to above may comprise a task to standardize each feature of the results considering the outputs of all QREs. That is, the decoding may serve to unify a feature under the same scale, same measure, and/or other parameter.
4. Let R be the set of all results from all QREs of Q, and let r be a unified result considering R. Results from a QRE may include, for example, execution time, number of two qubit gates, and number of physical qubits. In the generation of r, embodiments may employ various ensemble techniques, which may act as a merging function that receives all results R and returns the merged result r. Examples of ensemble techniques that may be employed in one or more embodiments include, but are not limited to, the following:
   a. One approach may consider using a majority process in which the most repeated results are considered for each feature—for example, the number of qubits, and gate error, associated with a quantum computing resource. Ties between different processes could be resolved arbitrarily or utilizing a second-level decision.
   b. Similar to a. above, rather than selecting the most frequent result of each feature, the mean value of the feature may instead be considered.
   c. The results may be weighted for each q, so that less efficient QREs will have less impact to the r. In this case, an embodiment may employ a weighted mean to select the feature value.
5. Next, a list L 114 of the most prominent quantum hardware that attains r is built. The building of the list L 114 considers database D 106, and r, where database D 106 transactions, that is, quantum devices, that do not meet the minimum requirements of r are removed from, or not included in, the list L 114. In an embodiment, the list L 114 is sorted by release date in ascending order, that is, with the most recent release date appearing at the top of the list L 114 so that newer devices will be shown first.
6. Next, one embodiment may bifurcate into two aspects, considering the output that the user is seeking:
   a. either the user only wants to know which quantum machines can satisfy the requirements described in the input problem U. If so, and as shown by 6a in the Figure, this example method skips to 8. (below), and considers that O=list L 114; or
   b. the user wants to know [1] which quantum machines can satisfy the problem requirements described in the input problem U, and the user would also like to know [2] further aspects in how the input problem U would perform in the quantum machines of list L 114. Therefore, an extra step in using a QRE 110 may be executed using the same scheme as in 3. It is noted that for ease of explanation, all QREs utilized in 3. may be considered as “general-purpose” QREs, where their results are approximate and do not refer to any particular hardware feature of database D 106. In this example aspect, the QRE 110 may be more specific to a hardware, where its resource requirements are more accurate. Having fulfilled the intent of the user associated with this aspect, the method may then move to 7 (below) as shown by 6b in FIG. 1.
7. Use, for every l∈L along with S*—that is, S after using Agent E/E/D—into a q*, a “specific” QRE that is the most suitable one for the quantum machine l. The selection of q* may be simplified by associating each transaction of database D 106 to a specific QRE. After running all QREs, an embodiment may consider O as the set of all results generated by all of the QREs 110, that is, a set of all estimates of quantum resources needed to solve the problem
8. Finally, an embodiment may use O as input to the LLM 104 so from which an LLM, which may or may not be the LLM 104, creates a human-readable output (O*) that may be provided to the user 102. This LLM could be the same LLM 104 but acting in translating the structured input of O into an unstructured format to the user, or could be an LLM other than LLM 104 that is trained specifically for generating texts like the one noted in this example method:
   a. in the case of an O from 7., the LLM 104 may translate the problem requirements, and each quantum machine capability from L will have to solve the input problem; or
   b. in the case of an O from 6.a, the LLM 104 will only consider L.

### B. Further Discussion

As disclosed herein, one or more embodiments may possess various useful features and aspects, although no embodiment is required to possess any of such features or aspects. The following examples are illustrative, but not exhaustive.

An embodiment may operate to decrease the cost incurred by non-experts in entering in the quantum domain by providing a more user friendly and intuitive interface. For example, an embodiment may increase interpretability of QRE results which, in turn, may lead to a more robust and informed decision-making process for supporting non-expert users. By way of contrast with one or more embodiments, the inventors are not presently aware of any conventional approach that employs LLM-based architecture and QREs to identify the most appropriate quantum hardware for solving a given input problem.

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### D. Further Example Embodiments

Following are some further example embodiments. These are presented only by way of example and are not intended to limit the scope of this disclosure or the claims in any way.

Embodiment 1. A method, comprising: receiving, by an LLM (large language model), an input prompt that comprises a description of a problem to be solved using quantum computing resources; by each QRE (quantum resource estimator) in an ensemble, determining, as an output of the QRE, a result that indicates the quantum computing resources needed to solve the problem; merging the QRE output results to generate a unified result; generating a list of available quantum computing resources that are able to meet requirements specified in the unified result; generating an output that is based on the list; and providing the output to the LLM, which uses the output to generate a human-readable output.

Embodiment 2. The method as recited in any preceding embodiment, wherein the LLM converts the prompt to a structured form prompt that is provided to respective agents associated with the QREs, the agents each encode the structured form prompt and transmit the encoded structured form prompt to a respective one of the QREs for use by the QRE in determining the quantum computing resources needed.

Embodiment 3. The method as recited in any preceding embodiment, wherein the merging takes place within the ensemble.

Embodiment 4. The method as recited in any preceding embodiment, wherein the input prompt is in text form.

Embodiment 5. The method as recited in any preceding embodiment, wherein the unified result is generated using an ensemble technique.

Embodiment 6. The method as recited in embodiment 5, wherein the ensemble technique comprises one of: a majority process; a feature frequency; or, a weighting process.

Embodiment 7. The method as recited in any preceding embodiment, wherein, prior to the merging and for each of the QREs, a respective agent decodes the result generated by the QRE so as to standardize each feature of the respective QRE results across the QREs in the ensemble.

Embodiment 8. The method as recited in any preceding embodiment, wherein the output that is based on the list is generated by identifying a specific one of the QREs that is best suited, as among the QREs in the ensemble, to run a respective one of the quantum computing resources in the list to solve the problem.

Embodiment 9. The method as recited in embodiment 8, wherein the best suited QREs run their respective quantum computing resources to solve the problem, and the output comprises results of the running of those quantum computing resources.

Embodiment 10. The method as recited in embodiment 9, wherein the output has an unstructured form.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

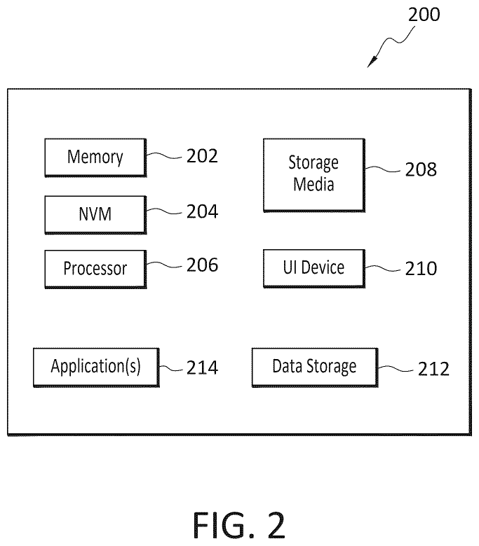

With reference briefly now to FIG. 2, any one or more of the entities disclosed, or implied, by FIG. 1, and/or elsewhere herein, may take the form of, or include, or be implemented on, or hosted by, a physical computing device, one example of which is denoted at 200. As well, where any of the aforementioned elements comprise or consist of a virtual machine (VM), that VM may constitute a virtualization of any combination of the physical components disclosed in FIG. 2.

In the example of FIG. 2, the physical computing device 200 includes a memory 202 which may include one, some, or all, of random access memory (RAM), non-volatile memory (NVM) 204 such as NVRAM for example, read-only memory (ROM), and persistent memory, one or more hardware processors 206, non-transitory storage media 208, UI device 210, and data storage 212. One or more of the memory components 202 of the physical computing device 200 may take the form of solid state device (SSD) storage. As well, one or more applications 214 may be provided that comprise instructions executable by one or more hardware processors 206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving, by an LLM (large language model), an input prompt that comprises a description of a problem to be solved using quantum computing resources;
by each QRE (quantum resource estimator) in an ensemble, determining, as an output of the QRE, a result that indicates the quantum computing resources needed to solve the problem;
merging the QRE output results to generate a unified result;
generating a list of available quantum computing resources that are able to meet requirements specified in the unified result;
generating an output that is based on the list; and
providing the output to the LLM, which uses the output to generate a human-readable output.

2. The method as recited in claim 1, wherein the LLM converts the prompt to a structured form prompt that is provided to respective agents associated with the QREs, the agents each encode the structured form prompt and transmit the encoded structured form prompt to a respective one of the QREs for use by the QRE in determining the quantum computing resources needed.

3. The method as recited in claim 1, wherein the merging takes place within the ensemble.

4. The method as recited in claim 1, wherein the input prompt is in text form.

5. The method as recited in claim 1, wherein the unified result is generated using an ensemble technique.

6. The method as recited in claim 5, wherein the ensemble technique comprises one of: a majority process; a feature frequency; or, a weighting process.

7. The method as recited in claim 1, wherein, prior to the merging and for each of the QREs, a respective agent decodes the result generated by the QRE so as to standardize each feature of the respective QRE results across the QREs in the ensemble.

8. The method as recited in claim 1, wherein the output that is based on the list is generated by identifying a specific one of the QREs that is best suited, as among the QREs in the ensemble, to run a respective one of the quantum computing resources in the list to solve the problem.

9. The method as recited in claim 8, wherein the best suited QREs run their respective quantum computing resources to solve the problem, and the output comprises results of the running of those quantum computing resources.

10. The method as recited in claim 9, wherein the output has an unstructured form.

11. A non-transitory storage medium having stored therein instructions that are executable by one or more hardware processors to perform operations comprising:
receiving, by an LLM (large language model), an input prompt that comprises a description of a problem to be solved using quantum computing resources;
by each QRE (quantum resource estimator) in an ensemble, determining, as an output of the QRE, a result that indicates the quantum computing resources needed to solve the problem;
merging the QRE output results to generate a unified result;
generating a list of available quantum computing resources that are able to meet requirements specified in the unified result;
generating an output that is based on the list; and
providing the output to the LLM, which uses the output to generate a human-readable output.

12. The non-transitory storage medium as recited in claim 11, wherein the LLM converts the prompt to a structured form prompt that is provided to respective agents associated with the QREs, the agents each encode the structured form prompt and transmit the encoded structured form prompt to a respective one of the QREs for use by the QRE in determining the quantum computing resources needed.

13. The non-transitory storage medium as recited in claim 11, wherein the merging takes place within the ensemble.

14. The non-transitory storage medium as recited in claim 11, wherein the input prompt is in text form.

15. The non-transitory storage medium as recited in claim 11, wherein the unified result is generated using an ensemble technique.

16. The non-transitory storage medium as recited in claim 15, wherein the ensemble technique comprises one of: a majority process; a feature frequency; or, a weighting process.

17. The non-transitory storage medium as recited in claim 11, wherein, prior to the merging and for each of the QREs, a respective agent decodes the result generated by the QRE so as to standardize each feature of the respective QRE results across the QREs in the ensemble.

18. The non-transitory storage medium as recited in claim 11, wherein the output that is based on the list is generated by identifying a specific one of the QREs that is best suited, as among the QREs in the ensemble, to run a respective one of the quantum computing resources in the list to solve the problem.

19. The non-transitory storage medium as recited in claim 18, wherein the best suited QREs run their respective quantum computing resources to solve the problem, and the output comprises results of the running of those quantum computing resources.

20. The non-transitory storage medium as recited in claim 19, wherein the output has an unstructured form.
